(19) United States
(12) Patent Application Publication
(10) Pub. No.: US 2026/0023497 A1
(43) Pub. Date: Jan. 22, 2026

(54) MEMORY DEVICES WITH DUAL PHASE TEMPERATURE SENSORS

(71) Applicant: MICRON TECHNOLOGY, INC., Boise, ID (US)

(72) Inventors: Aravind Polkampally, Nalgonda (IN); Rakesh Keshava Kukkundoor, Hyderabad (IN)

(21) Appl. No.: 19/256,373

(22) Filed: Jul. 1, 2025

Related U.S. Application Data
(60) Provisional application No. 63/671,860, filed on Jul. 16, 2024.

(51) Int. Cl. G06F 3/06

(52) U.S. Cl. CPC G06F 3/0653; G06F 3/0604; G06F 3/0679

(57) ABSTRACT

A system includes a memory array, a temperature sensor including a temperature-dependent circuit, a ramp voltage source producing a ramp voltage that increases from a predefined starting value, and at least one processing device, operatively coupled with the memory array, the temperature sensor, and the ramp voltage source. The at least one processing device is to perform operations including determining a reference phase value reflecting a first amount of time for the ramp voltage starting at the predefined starting value to reach a reference voltage value, determining a sampling phase value reflecting a second amount of time for the ramp voltage starting at the predefined starting value to reach a temperature-dependent voltage value produced by the temperature-dependent circuit, and causing, based on the reference phase value and the sampling phase value, a temperature within the memory device to be determined.

### CROSS-REFERENCE TO RELATED APPLICATION(S)

The present application claims the benefit of U.S. Provisional Patent Application No. 63/671,860, filed on Jul. 16, 2024, the entire contents of which are hereby incorporated by reference herein.

### TECHNICAL FIELD

Embodiments of the disclosure relate generally to memory sub-systems, and more specifically, relate to memory devices with dual phase temperature sensors.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure.

FIG. 2 is a block diagram of a memory device in communication with a memory sub-system controller of a memory sub-system, in accordance with some embodiments of the present disclosure.

FIG. 3A is a block diagram of example circuitry of a temperature sensor, in accordance with some embodiments of the present disclosure.

FIG. 3B is a schematic diagram of example voltage generator circuitry of a temperature sensor, in accordance with some embodiments of the present disclosure.

FIG. 3C is a schematic diagram of example dual phase control circuitry of a temperature sensor, in accordance with some embodiments of the present disclosure.

FIG. 3D is a schematic diagram of example phase value circuitry of a temperature sensor, in accordance with some embodiments of the present disclosure.

FIGS. 4A-4C are diagrams illustrating example operations of a temperature sensor, in accordance with some embodiments of the present disclosure.

FIGS. 5A-5C are flow diagrams of example methods to use dual phase temperature sensors for memory devices, in accordance with some embodiments of the present disclosure.

FIG. 6 is a block diagram of an example computer system in which embodiments of the present disclosure may operate.

### DETAILED DESCRIPTION

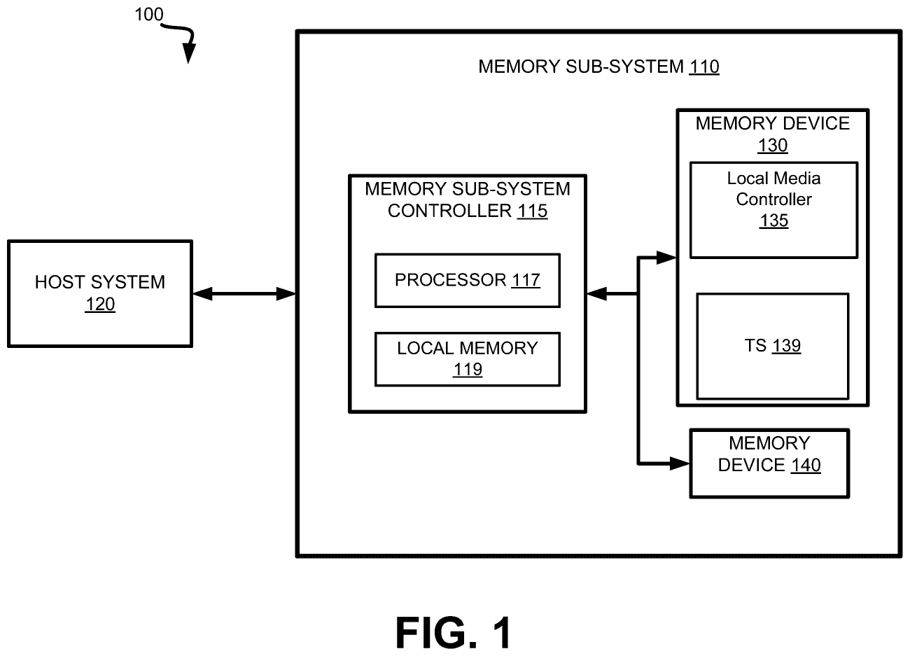

Aspects of the present disclosure are directed to memory devices with dual phase temperature sensors. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include of one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A temperature sensor within a memory device can include a temperature-dependent circuit that changes its electrical characteristics with temperature, thus allowing to determine, e.g., one or more voltage values that reflect the temperature within the memory device in a region surrounding the temperature sensor. The voltage values can then be converted into a temperature measurement in the region. In some implementations, a temperature sensor is a digital temperature sensor.

The temperature measured by the temperature sensor can be used by the local media controller to control operation of the memory device. For example, the local media controller can control operation of the memory device to prevent overheating, reduce thermal stress, improve data reliability, etc. Accordingly, temperature monitoring using temperature sensors can be used to improve memory device performance.

Temperature sensors, like many electronic components, can have inherent inaccuracies or variations in their output readings. A temperature sensor can be calibrated to address these inaccuracies or variations and improve temperature measurement accuracy. Calibration, also referred to as trimming, refers to the adjustment of the output of a temperature sensor to match a known reference or standard. A temperature sensor can be calibrated with respect to multiple temperature values. For example, a temperature sensor can be calibrated at a “hot” temperature value and at a “low” temperature value. Illustratively, the hot temperature value can be 90° C. and the low temperature value can be −10° C. That is, a temperature sensor can be calibrated such that the error at 90° C. will be zero and the error at −10° C. will be zero.

A temperature sensor that can be calibrated at a single temperature can be designed to have a smaller surface area on the memory device as compared to temperature sensors that are calibrated at multiple temperatures. For example, less circuitry would be needed to implement single temperature calibration as compared to multi-temperature calibration. Reducing the size of the temperature sensor can increase the number of temperature sensors that can fit within the memory device. For example, a temperature sensor can be made for each page group to improve temperature measurement accuracy.

Aspects of the present disclosure address the above and other deficiencies by using temperature sensors that are calibrated at a single temperature, such that the error at the single temperature will be below a predefined error threshold. In some implementations, the single temperature is a hot temperature value. For example, the hot temperature value can be 90° C. (e.g., the error at 90° C. will be approximately zero).

A dual phase scheme can be used to calibrate a temperature sensor and/or operate the calibrated temperature sensor. More specifically, the dual phase scheme includes a reference phase in which the temperature sensor determines a reference phase value using a predefined reference voltage value (V_{ref}). The reference phase value reflects an amount of time for Vᵣₐₘₚ starting at Vₛₜₐᵣₜ to reach V_{ref} (“reference phase time”). The dual phase scheme further includes a sampling phase in which the temperature sensor determines a sampling phase value using a predefined temperature-dependent voltage value. The sampling phase value reflects an amount of time for Vᵣₐₘₚ starting at Vₛₜₐᵣₜ to reach the temperature-dependent voltage. (“sampling phase time”).

Operation of the reference phase and the sampling phase can be respectively controlled to generate a ramp voltage (Vᵣₐₘₚ) that is increased over time until it reaches V_{ref} during the reference phase, and the temperature-dependent voltage value during the sampling phase. The value of Vᵣₐₘₚ for both the reference phase and the sampling phase is initially set at a predefined starting value (Vₛₜₐᵣₜ). In some embodiments, Vₛₜₐᵣₜ is greater than zero volts (V). This can reduce the amount of time it takes to increase Vᵣₐₘₚ to the reference voltage value during the reference phase, and the temperature-dependent voltage value during sampling phase.

V_{ref} can be obtained from voltage generator circuitry, as described in further detail below. In some implementations, the reference phase value is a reference phase count obtained using a reference phase counter. More specifically, the reference phase count is defined as the number of clock signal (clk) pulses or cycles needed for Vᵣₐₘₚ to match V_{ref}. The reference phase time can be determined as the product of the reference phase count and a length of time of a single pulse (e.g., from rising edge to rising edge).

The temperature-dependent voltage value is derived from a voltage source that has a known relationship to at least some temperatures. Thus, information indicative of when Vᵣₐₘₚ matches the temperature-dependent voltage value during the sampling phase can be used to determine a corresponding temperature. In some implementations, the temperature-dependent voltage value is a base-to-emitter voltage (V_{be}). For example, V_{be} can be defined by current flowing between a base of a transistor of a bandgap circuit and an emitter of the transistor. The magnitude of V_{be} generally decreases as temperature increases. In some implementations, the sampling phase value is a sampling phase count obtained using a sampling phase counter. More specifically, the sampling phase count is defined as the number of clk pulses or cycles needed for Vᵣₐₘₚ to match the temperature-dependent voltage value (e.g., V_{be}). The sampling phase time can be determined as the product of the sampling phase count and the length of time of a single clk pulse (e.g., from rising edge to rising edge).

As mentioned above, the temperature-dependent voltage value (e.g., V_{b}) has a known relationship to some temperatures (e.g., 0° C.). Thus, in some implementations, the value of V_{ref} is tuned to (e.g., set equal to) the temperature-dependent voltage value (e.g., V_{be}) at a particular temperature of which the behavior of the temperature-dependent voltage value is known. By tuning V_{ref} to the temperature-dependent voltage value at the particular temperature, the error at the particular temperature can be minimized (e.g., approximately zero). For example, if the particular temperature is 0° C., then V_{ref} can be tuned to the temperature-dependent voltage value at 0° C. such that the error at 0° C. will be approximately zero. Tuning V_{ref} to the temperature-dependent voltage value at the particular temperature (e.g., 0° C.) is a feature that enables the temperature sensor to be calibrated (e.g., trimmed) at a single temperature (e.g., 90° C.) instead of multiple temperatures.

During calibration, the temperature sensor can store a reference phase value obtained during the reference phase (“calibration reference phase value”) in a calibration reference phase value register, and a calibration sampling phase value obtained during the sampling phase (“calibration sampling reference phase value”) to be stored in a calibration sampling phase value register. In some implementations, the calibration reference phase value register and the calibration sampling phase value register are included in the temperature sensor. In some implementations, the calibration reference phase value register and the calibration sampling phase value register are included in the local media controller.

The calibration reference phase value and the calibration sampling phase value can define at least a subset of a set of calibration parameters. As will be described in further detail below, after calibration, the calibrated temperature sensor or the local media controller can then use a set of parameters including the reference phase value and the sampling phase value, in conjunction with the set of calibration parameters, to determine the temperature. Further details regarding using temperature sensors that are calibrated at a single temperature will be described herein below with reference to FIGS. 1-6.

Advantages of the present disclosure include, but are not limited to, lower cost and improved reliability and performance. For example, a temperature sensor described herein can have a smaller surface area on the memory device. This can enable a temperature sensor to be made for each page group to improve temperature measurement accuracy. As another example, by only requiring a single calibration operation, temperature sensor calibration time can be reduced. As yet another example, the dual phase scheme described herein can be performed to account for inaccuracies or variations of outputs of one or more components of the digital sensor. For example, there may be inaccuracies or variations with respect to the current provided by the current source that is used to generate Vᵣₐₘₚ. As another example, there may be inaccuracies or variations with respect to the source of clk.

FIG. 1 illustrates a computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes at least one temperature sensor (TS) 139. The TS 139 can be calibrated (e.g., trimmed) at a single temperature, such that the error at the single temperature will be approximately zero. The TS 139 can be calibrated and/or operated using a dual phase scheme. More specifically, the dual phase scheme includes a reference phase and a sampling phase. Operation of each phase of the dual phase scheme can be respectively controlled using dual phase control circuitry that produces a ramp voltage (Vᵣₐₘₚ) that increases over time until Vᵣₐₘₚ reaches a respective predefined voltage value for the phase.

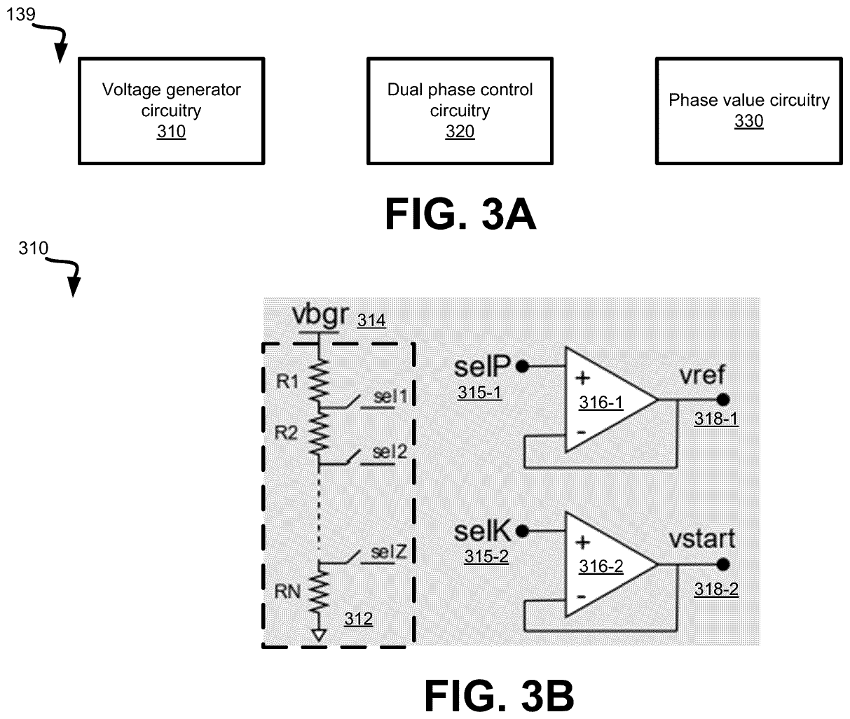

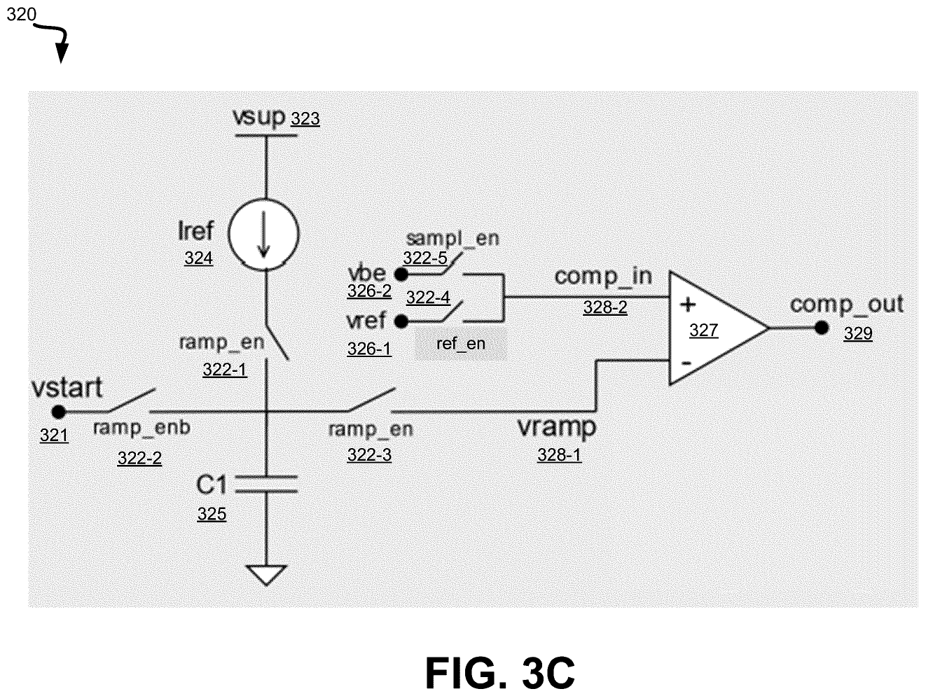

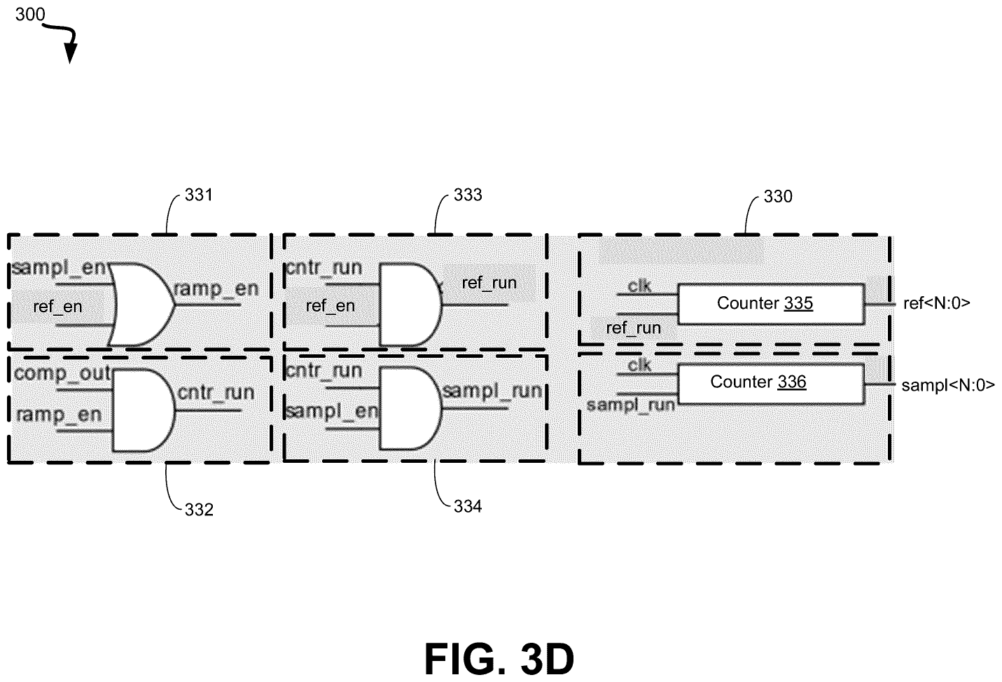

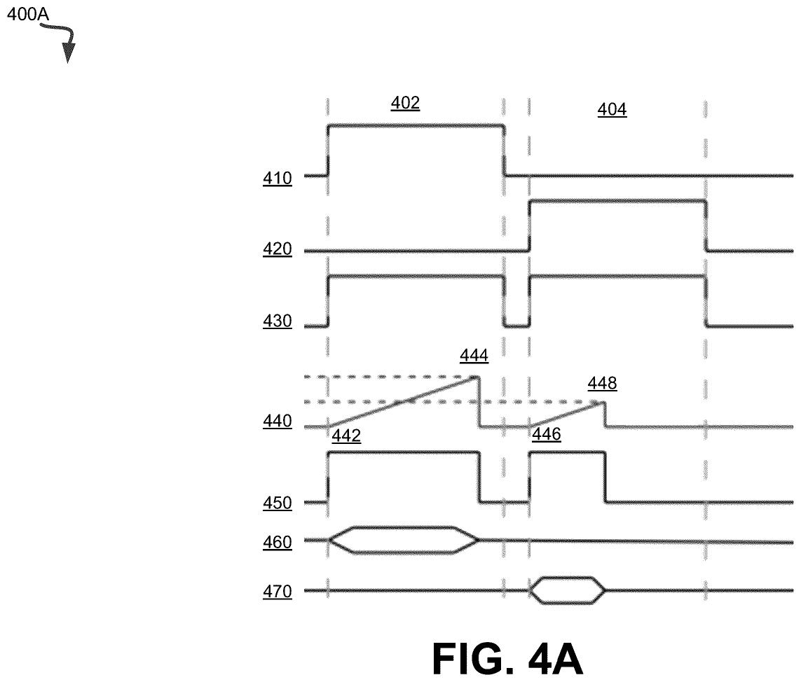

For example, the predefined voltage value for the reference phase can be a reference voltage value (V_{ref}). V_{ref} can be generated by voltage generator circuitry, as will be described in further detail below with reference to FIGS. 3A-3B. When the reference phase is enabled by a reference phase enable signal (ref_en), as will be described in further detail below with reference to FIGS. 3A-3D, Vᵣₐₘₚ is increased over time until Vᵣₐₘₚ reaches V_{ref}.

The TS 139 and/or the local media controller 135 can determine a reference phase value reflecting an amount of time for Vᵣₐₘₚ starting at Vₛₜₐᵣₜ to reach V_{ref}. The amount of time can be referred to as “a reference phase time.” In some implementations, the reference phase value is a reference phase count. More specifically, the reference phase count is the number of clock (clk) pulses that were counted for Vᵣₐₘₚ to reach V_{ref} during the reference phase. The reference phase time can be determined as the product of the reference phase count and a length of time of a single pulse (e.g., from rising edge to rising edge). The reference phase value (e.g., count) can be determined by phase value circuitry, as will be described in further detail below with reference to FIGS. 3A-3D.

As another example, the predefined voltage value for the sampling phase can be a temperature-dependent voltage value (e.g., V_{be}). In some implementations, V_{be} can be obtained from a bandgap reference circuit. For example, the bandgap reference circuit can be a standby low power (SLP) bandgap reference circuit. When the sampling phase is enabled by a sampling phase enable signal (sampl_en) as will be described in further detail below with reference to FIGS. 3A-3D, Vᵣₐₘₚ is increased over time until Vᵣₐₘₚ reaches V_{be}.

The TS 139 and/or the local media controller 135 can determine a sampling phase value reflecting an amount of time for Vᵣₐₘₚ starting at Vₛₜₐᵣₜ to reach the temperature-dependent voltage value (e.g., V_{be}). The amount of time can be referred to as “a sampling phase time.” In some implementations, the sampling phase value is a sampling phase count. More specifically, the sampling phase count is the number of clk pulses that were counted for Vᵣₐₘₚ to reach the temperature-dependent voltage value during the sampling phase. The sampling phase time can be determined as the product of the reference phase count and a length of time of a single pulse (e.g., from rising edge to rising edge). The sampling phase value (e.g., count) can be determined by phase value circuitry, as will be described in further detail below with reference to FIGS. 3A-3D.

In some implementations, Vᵣₐₘₚ for both the reference phase and the sampling phase is initially set at Vₛₜₐᵣₜ, which is greater than 0 V. Vₛₜₐᵣₜ can also be generated by the voltage generator circuitry (e.g., selected as a voltage generated by the resistor ladder), as will be described in further below. Initializing Vᵣₐₘₚ to Vₛₜₐᵣₜ can reduce the amount of time it takes to ramp Vᵣₐₘₚ to the respective predefined voltages (e.g., V_{ref} and V_{be}). In some implementations, V_{ref} is chosen to be equal to V_{be} at a particular temperature, such that the error at the particular temperature will be approximately zero. For example, the particular temperature can be 0° C., and the error at 0° C. will be approximately zero.

Temperature of a region of the memory device 130 measured by the temperature sensor can be determined from the calibration temperature, the calibration time metric (e.g., reference phase count) and the sampling time metric (e.g., sampling phase count). Further details regarding the operations of the TS 139 will be described below with reference to FIGS. 3A-6.

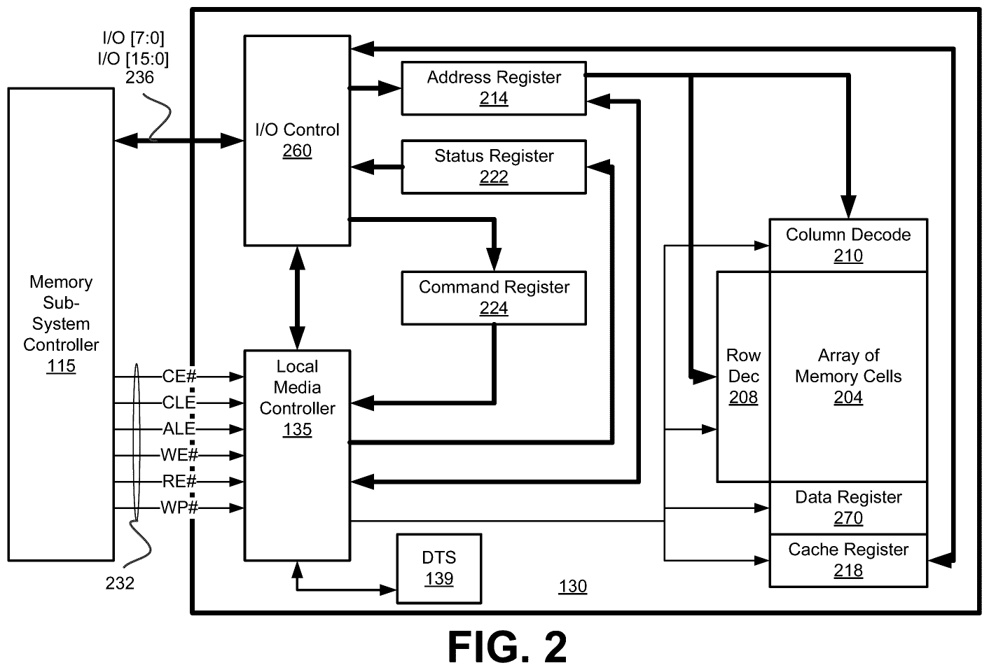

FIG. 2 is a simplified block diagram of a first apparatus, in the form of a memory device 130, in communication with a second apparatus, in the form of a memory sub-system controller 115 of a memory sub-system (e.g., memory sub-system 110 of FIG. 1), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 204 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 2) of at least a portion of array of memory cells 204 are capable of being programmed to one of at least two target data states.

Row decode circuitry 208 and column decode circuitry 210 are provided to decode address signals. Address signals are received and decoded to access the array of memory cells 204. Memory device 130 also includes input/output (I/O) control circuitry 260 to manage input of commands, addresses and data to the memory device 130 as well as output of data and status information from the memory device 130. An address register 214 is in communication with I/O control circuitry 260 and row decode circuitry 208 and column decode circuitry 210 to latch the address signals prior to decoding. A command register 224 is in communication with I/O control circuitry 260 and local media controller 135 to latch incoming commands.

A controller (e.g., the local media controller 135 internal to the memory device 130) controls access to the array of memory cells 204 in response to the commands and generates status information for the external memory sub-system controller 115, i.e., the local media controller 135 is configured to perform access operations (e.g., read operations, programming operations and/or erase operations) on the array of memory cells 204. The local media controller 135 is in communication with row decode circuitry 208 and column decode circuitry 210 to control the row decode circuitry 208 and column decode circuitry 210 in response to the addresses.

The local media controller 135 is also in communication with a cache register 218. Cache register 218 latches data, either incoming or outgoing, as directed by the local media controller 135 to temporarily store data while the array of memory cells 204 is busy writing or reading, respectively, other data. During a program operation (e.g., write operation), data may be passed from the cache register 218 to the data register 270 for transfer to the array of memory cells 204; then new data may be latched in the cache register 218 from the I/O control circuitry 260. During a read operation, data may be passed from the cache register 218 to the I/O control circuitry 260 for output to the memory sub-system controller 115; then new data may be passed from the data register 270 to the cache register 218. The cache register 218 and/or the data register 270 may form (e.g., may form a portion of) a page buffer of the memory device 130. A page buffer may further include sensing devices (not shown in FIG. 2) to sense a data state of a memory cell of the array of memory cells 204, e.g., by sensing a state of a data line connected to that memory cell. A status register 222 may be in communication with I/O control circuitry 260 and the local memory controller 135 to latch the status information for output to the memory sub-system controller 115.

Memory device 130 receives control signals at the memory sub-system controller 115 from the local media controller 135 over a control link 232. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 232 depending upon the nature of the memory device 130. In some embodiments, memory device 130 receives command signals (which represent commands), address signals (which represent addresses), and data signals (which represent data) from the memory sub-system controller 115 over a multiplexed input/output (I/O) bus 236 and outputs data to the memory sub-system controller 115 over I/O bus 236.

For example, the commands may be received over input/output (I/O) pins [7:0] of I/O bus 236 at I/O control circuitry 260 and may then be written into command register 224. The addresses may be received over input/output (I/O) pins [7:0] of I/O bus 236 at I/O control circuitry 260 and may then be written into address register 214. The data may be received over input/output (I/O) pins [7:0] for an 8-bit device or input/output (I/O) pins [15:0] for a 16-bit device at I/O control circuitry 260 and then may be written into cache register 218. The data may be subsequently written into data register 270 for programming the array of memory cells 204.

In an embodiment, cache register 218 may be omitted, and the data may be written directly into data register 270. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 2 has been simplified. It should be recognized that the functionality of the various block components described with reference to FIG. 2 may not necessarily be segregated to distinct components or component portions of an integrated circuit device. For example, a single component or component portion of an integrated circuit device could be adapted to perform the functionality of more than one block component of FIG. 2. Alternatively, one or more components or component portions of an integrated circuit device could be combined to perform the functionality of a single block component of FIG. 2. Additionally, while specific I/O pins are described in accordance with popular conventions for receipt and output of the various signals, it is noted that other combinations or numbers of I/O pins (or other I/O node structures) may be used in the various embodiments.

FIG. 3A is a block diagram of circuitry 300 of the TS 139 in accordance with some embodiments of the present disclosure. As shown, the TS 139 can include voltage generator circuitry 310. The voltage generator circuitry 310 can generate a set of voltages including V_{ref}. In some implementations, the set of voltages can further include Vₛₜₐᵣₜ, which is greater than 0 V. An example implementation of the voltage generator circuitry 310 will now be described below with reference to FIG. 3B.

FIG. 3B is a schematic diagram of voltage generator circuitry 310 in accordance with some embodiments of the present disclosure. The voltage generator circuitry 310 includes a select signal (sel) generator 312. The sel generator 312 is used generate a set of select signals (e.g., “sel1” through “selZ”). In some implementations, and as shown in FIG. 3B, the sel generator 312 can be implemented using a resistor ladder in which an end of the initial resistor of the resistor ladder (“R1”) is coupled to a voltage source 314, an end of the final resistor of the resistor ladder (“RN”) is coupled to ground (GND), and an end of each resistor of the resistor ladder (“R1” through “RN”) is coupled to a respective switch that provides a respective select signal (“sel1” through “selZ”) when closed. In some implementations, and a shown in FIG. 3B, the voltage source 314 is a bandgap voltage reference (V_{bgr}) source. More specifically, a V_{bgr} source can be a bandgap reference circuit that includes any suitable combination of circuit elements to generate V_{bgr} as an output. The set of select signals can include selP 315-1 and selK 315-2. In some implementations, and as shown in FIG. 3B, the voltage generator circuitry 310 further includes a set of comparators including comparator 316-1 and comparator 316-2. Comparator 316-1 can receive selP 315-1 as input to generate V_{ref} 318-1, and comparator 316-2 can receive selK 315-2 as input to generate Vₛₜₐᵣₜ 318-2. For example, a local media controller (e.g., the local media controller 135 of FIGS. 1-2) can send a command to the TS 139 to select selP 315-1 and selK 315-2 as inputs to generate V_{ref} 318-1 and Vₛₜₐᵣₜ 318-2, respectively.

Referring back to FIG. 3A, the TS 139 can further include dual phase control circuitry 320. The dual phase control circuitry 320 can selectively control operation of the reference phase and the sampling phase of a dual phase scheme used to calibrate and/or operate the TS 139. In some implementations, the dual phase control circuitry includes a ramp voltage source to produce a ramp voltage that increases from Vₛₜₐᵣₜ to V_{ref} during the reference phase and that increases from Vₛₜₐᵣₜ to the temperature-dependent voltage value (e.g., V_{be}) during the sampling phase. For example, Vₛₜₐᵣₜ can be set by the voltage generator circuitry 310. An example implementation of the dual phase control circuitry 320 will now be described below with reference to FIG. 3C.

FIG. 3C is a schematic diagram of dual phase control circuitry 320 in accordance with some embodiments of the present disclosure. As shown, the dual phase control circuitry 320 can include Vₛₜₐᵣₜ source 321, a set of switches 322-1 through 322-5, a supply voltage (Vₛᵤₚ) source 323, a reference current (I_{ref}) source 324, a capacitor 325, a V_{ref} source 326-1, a temperature-dependent voltage value source 326-2, and a comparator 327. In this illustrative example, temperature-dependent voltage value source 326-2 is a V_{be} source. In some implementations, V_{be} source 326-2 includes a bandgap reference circuit (e.g., SLP bandgap reference circuit). In some implementations, Vᵣₐₘₚ 328-1 is initially set at Vₛₜₐᵣₜ, which can be greater than 0 V. In some implementations, V_{ref} 326-1 is chosen to be equal to V_{be} 326-2 at a particular temperature, such that the error at the particular temperature will be approximately zero. For example, the particular temperature can be 0° C., and the error at 0° C. will be approximately zero.

Each of the switches 322-1 through 322-5 is controlled by a control signal. For example, switch 322-1 can be closed when a ramp enable signal (ramp_en) is asserted and opened when ramp_en is deasserted. Switch 322-2 can be closed when an inverse ramp enable signal (ramp_enb) is asserted and opened when ramp_enb is deasserted. Switch 322-3 can be closed when ramp_en is asserted and opened when ramp_en is deasserted. Switch 322-4 can be closed when ref_en is asserted and opened when ref_en is deasserted. The reference phase is enabled when switch 322-4 is closed and disabled when switch 322-4 is opened. Switch 322-5 can be closed when sampl_en is asserted and opened when sampl_en is deasserted. The sampling phase is enabled when switch 322-5 is closed and disabled when switch 322-5 is opened. As will be described in further detail below with reference to FIG. 3D, ramp_en can be generated as an output of an OR gate having respective input terminals connected to sampl_en and ref_en. In other words, ramp_en will be asserted to enable ramp voltage generation if at least one of sampl_en or ref_en is asserted. Moreover, ramp_en will be deasserted to disable ramp voltage generation if both sampl_en and ref_en are deasserted.

Vᵣₐₘₚ 328-1 is one input to the comparator 327. Vᵣₐₘₚ 328-1 is initially set at Vₛₜₐᵣₜ. During the reference phase or the sampling phase, the I_{ref} source 324 charges the capacitor 325. The current flowing into the capacitor 325 causes the voltage across the capacitor 325 to increase linearly over time, thus increasing Vᵣₐₘₚ 328-1.

Comparator input (comp_in) 328-2 is another input to the comparator 327. Comp_in 328-2 is either V_{ref} produced by V_{ref} source 326-1 or the temperature-dependent voltage value (e.g., V_{be}) produced by the temperature-dependent voltage value source 326-2, depending on which of the reference phase or the sampling phase is currently enabled.

The comparator 327 produces a comparator output (comp_out) 329 based on Vᵣₐₘₚ 328-1 and comp_in 328-2. Each phase of the dual phase scheme can be terminated when comp_out 329 has a logical level that indicates that Vᵣₐₘₚ 328-1 has reached comp_in 328-2. In some implementations, the logical level that indicates that Vᵣₐₘₚ 328-1 has reached comp_in 382-2 is a low logical value (e.g., 0). For example, the reference phase can be terminated when comp_out 329 has a logical level that indicates that Vᵣₐₘₚ 328-1 is approximately equal to V_{ref} 326-1. As another example, the sampling phase can be terminated when comp_out 329 has a logical level that indicates that Vᵣₐₘₚ 328-1 is approximately equal to the temperature-dependent voltage value 326-2 (e.g., V_{be}). Otherwise, comp_in 328-2 will have a logical level that indicates that Vᵣₐₘₚ 328-1 has not reached comp_in 328-2, such as a high logical value (e.g., 1). Upon termination of the reference phase or the sampling phase, the ramp voltage generation is disabled and the capacitor 325 can be discharged.

Referring back to FIG. 3A, the TS 139 can further include phase value circuitry 330. The phase value circuitry 330 can generate the reference phase value during the reference phase and the sampling phase value during the sampling phase. For example, the reference phase value can be a reference phase count corresponding to a number of clock signal pulses until the ramp voltage reaches V_{ref} during the reference phase. The reference phase time can be determined as the product of the reference phase count and a length of time of a single pulse (e.g., from rising edge to rising edge). As another example, the sampling phase value can be sampling phase count corresponding to a number of clock signal pulses until the ramp voltage reaches the temperature-dependent value during the sampling phase. The sampling phase time can be determined as the product of the sampling phase count and a length of time of a single pulse (e.g., from rising edge to rising edge). An example implementation of the phase value circuitry 330 will now be described below with reference to FIG. 3D.

FIG. 3D is a schematic diagram of example portion of the circuitry 300, in accordance with some embodiments of the present disclosure. As shown, the circuitry 300 can include a ramp_en generator 331. For example, the ramp_en generator 331 can include an OR gate having input terminals to receive sampl_en and ref_en to generate ramp_en. The circuitry 300 can further include a counter run signal (cntr_run) generator 332. For example, the cntr_run generator can include an AND gate having input terminals to receive comp_out (generated by comparator 327) and ramp_en to generate cntr_run.

The circuitry 300 can further include the phase value circuitry 330. In some implementations, and as shown in FIG. 3D, the phase value circuitry 330 incudes a reference phase counter (“counter”) 335 and a sampling phase counter (“counter”) 336.

The circuitry 300 can further include a reference run signal (ref_run) generator 333 to generate ref_run. Ref_run is a signal that, when asserted, causes the counter 335 to begin counting the number of clock signal pulses with respect to the clock signal during the reference phase. For example, the ref_run generator 333 can include an AND gate having input terminals to receive entr_run and ref_en to generate ref_run. More specifically, the counter 335 starts counting the number of clock signal pulses upon initiation of the reference phase when enabled by ref_run. The counter 335 can then output a reference phase counter signal indicative of the number of clock signal pulses (and thus time) needed for Vᵣₐₘₚ to match V_{ref}.

The circuitry 300 can further include a sample run signal (sampl_run) generator 334 to generate sampl_run. Sampl_run is a signal that, when asserted, causes the counter 336 to begin counting the number of clock signal pulses with respect to the clock signal during the sampling phase. For example, the sampl_run generator 334 can include an AND gate having input terminals to receive cntr_run and sampl_en to generate sampl_run. More specifically, the counter 336 starts counting the number of pulses upon initiation of the sampling phase when enabled by sampl_run. The counter 336 can then output a sampling phase counter signal indicative of the number of clock signal pulses (and thus time) needed for Vᵣₐₘₚ to match the temperature-dependent temperature value (e.g., V_{be}).

The counters 335 and 336 can be N bit counters, in which the reference phase counter signal is represented by ref <N−1:0> and sample phase counter signal is represented by sampl <N−1:0>. In some implementations, the counters 335 and 336 are 9 bit counters, in which the reference counter signal is of the form ref <8:0> and the sampling counter signal is of the form sampl <8:0>. However, such examples should not be considered limiting.

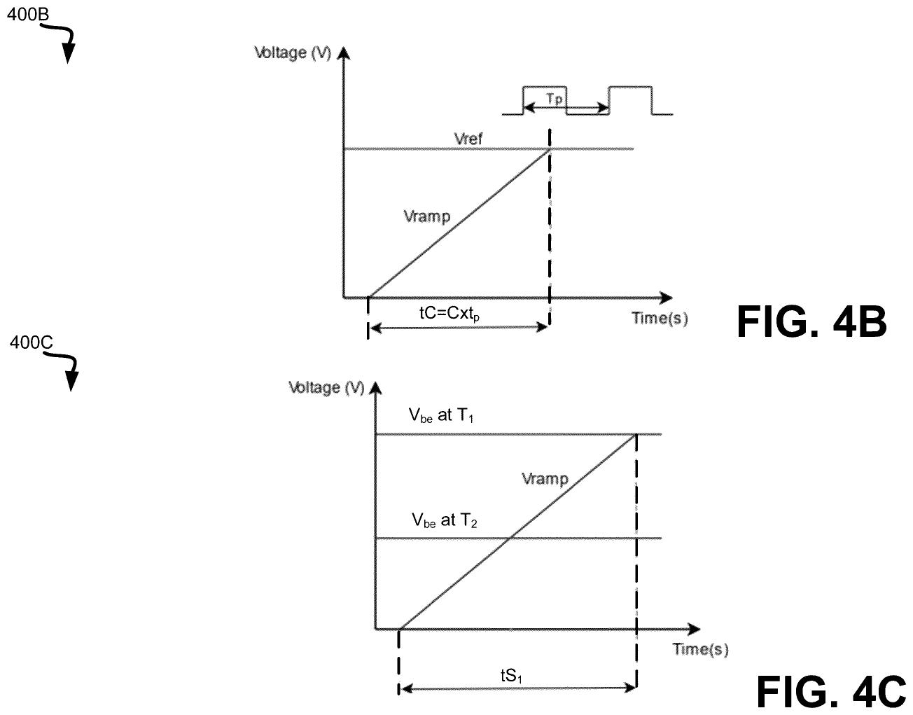

FIG. 4A is a diagram 400A illustrating an example operation of a temperature sensor (e.g., TS 139 of FIG. 1) during a reference phase 402 and a sampling phase 404 of a dual phase scheme, in accordance with some embodiments of the present disclosure. More specifically, diagram 400A is a timing diagram of signals including ref_en 410, sampl_en 420, ramp_en 430, Vᵣₐₘₚ 440, comp_out 450, ref<N: 0>460, and sampl<N: 0>470.

The reference phase 402 is enabled when ref_en 410 goes from low to high, sampl_en 420 is low, and ramp_en 430 goes from low to high. In this example, it is assumed that Vᵣₐₘₚ 440 is initially at Vₛₜₐᵣₜ (e.g., a voltage greater than 0° C.). Comp_out 450 is high when Vᵣₐₘₚ 440 is less than V_{ref}. At time 442, the magnitude of Vᵣₐₘₚ 440 can be increased (e.g., by continuing to use the I_{ref} source 324 to charge the capacitor 325 of FIG. 3C) from Vₛₜₐᵣₜ until Vᵣₐₘₚ 440 is approximately equal to V_{ref} and comp_out 450 is low at time 444. This can cause ramp_en 430 to go from high to low and cause Vᵣₐₘₚ 440 to drop back down to Vₛₜₐᵣₜ (e.g., by disconnecting I_{ref} source 324 from the capacitor 325 to discharge the capacitor 325). Ref<N: 0>460 is the reference phase value generated during the reference phase 402 (e.g., reference phase count generated by a reference phase counter, such as the reference phase counter 335 of FIG. 3D).

The sampling phase 404 is enabled when sampl_en 420 goes from low to high, ref_en 410 is low, and ramp_en 430 goes from low to high. In this example, it is assumed again that Vᵣₐₘₚ 440 is initially at Vₛₜₐᵣₜ. Comp_out 450 is high when Vᵣₐₘₚ 440 is less than V_{be}. At time 446, the magnitude of Vᵣₐₘₚ 440 can be increased (e.g., by continuing to use the I_{ref} source 324 to charge the capacitor 325 of FIG. 3C) from Vₛₜₐᵣₜ until Vᵣₐₘₚ 440 is approximately equal to V_{be} and comp_out 450 is low at time 448. This can cause ramp_en 430 to go from high to low and cause Vᵣₐₘₚ 440 to drop back down to Vₛₜₐᵣₜ (e.g., by disconnecting I_{ref} source 324 from the capacitor 325 to discharge the capacitor 325). Sampl<N: 0>470 is the sampling phase value generated during the sampling phase 404 (e.g., sampling phase count generated by a sampling phase counter, such as the sampling phase counter 336 of FIG. 3D).

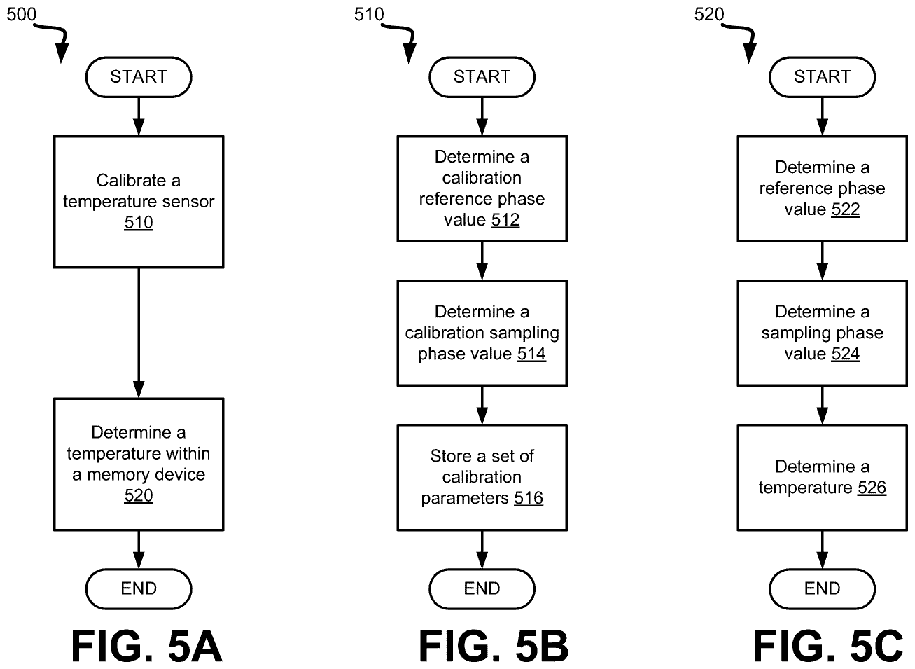

Further details regarding the reference phase 402 and the sampling phase 404, including using the reference phase value and the sampling phase value to determine temperature, will now be described below with reference to FIGS. 4B-5.

FIG. 4B is a diagram 400B illustrating an example operation of a temperature sensor during a reference phase, in accordance with some embodiments of the present disclosure. More specifically, diagram 400B is a graph with an X-axis corresponding to time in seconds(s) and a Y-axis corresponding to voltage (V) over time. As shown, Vᵣₐₘₚ is increased over time until Vᵣₐₘₚ reaches V_{ref}. For example, as described above with reference to FIG. 3C, a comparator can be used to compare Vᵣₐₘₚ to V_{ref} when the reference phase is enabled, and the reference phase can be terminated when the comparator output signal is approximately zero. The reference phase time (tC) is equal to the product of the reference phase count (R) and clock time (tₚ), which is defined as the time between consecutive rising edges of a clock signal.

FIG. 4C is a diagram illustrating an example operation of a temperature sensor during a sampling phase, in accordance with some embodiments of the present disclosure. More specifically, diagram 400C is a graph with an X-axis corresponding to time in seconds(s) and a Y-axis corresponding to voltage (V) over time. The V_{be} at a first temperature (T₁) and the V_{be} at a second temperature (T₂) are shown. The first temperature can correspond to a minimum operating temperature of the memory device, and the second temperature can correspond to a maximum operating temperature of the memory device. In some implementations, T₁ is about-40° C. and T₂ is about 125° C.

As shown, Vᵣₐₘₚ is increased over time until Vᵣₐₘₚ reaches V_{be} at T₁. For example, as described above with reference to FIG. 3C, a comparator can be used when the sampling phase is enabled to compare Vᵣₐₘₚ to V_{be}, and the sampling phase can be terminated when the comparator output signal is approximately zero. The sampling phase time from 0 V to V_{be} at T₁ is shown as tS₁, which is equal to the product of tₚ and the sampling phase count at T₁. The sampling phase count at T₁ is also referred to as S₁. The sampling phase time from 0 V to V_{be} at T₂ is equal to the product of tₚ and the sampling phase count at T₂. The sampling phase count at T₂ is also referred to as S₂.

The temperature sensor can cause a temperature (T) to be determined based on a set of parameters. In some implementations, the temperature sensor determines T based on the set of parameters. In some implementations, the temperature sensor sends at least one parameter of the set of parameters to the local media controller, and the local media controller determines T based on the set of parameters.

The temperature T can be determined from the calibration temperature (T_{cal}), which is the temperature at which calibration of the temperature sensor was performed. In some implementations, the set of parameters includes T_{cal}. The temperature T can be determined by modifying T_{cal} based on a value derived from the calibration sampling phase value (PS), a corrected reference phase value (CR), and a resolution value of the digital sensor (V). In some implementations, the value is determined as the difference between PS and CR, divided by V. That is,

$$T = {T}_{c al} + \frac{PS - CR}{V} .$$

CR can be determined based on the reference phase value (e.g., count) determined by the calibrated temperature sensor (R), the sampling phase value (e.g., count) determined by the calibrated temperature sensor(S) and a calibration reference phase value (e.g., count) (PR). PR is the reference phase value obtained during the reference phase performed during the calibration of the temperature sensor. In some implementations, CR is determined as the product of S, and a ratio of PR and

$$R ( CR = S \times \frac{PR}{R} ) .$$

In some implementations, CR is approximated by subtracting, from S, the difference between R and the PR (CR=S−(R−PR)).

Generally, the resolution value V defines the number of counts per degree Celsius. In some implementations, V is determined using the following equation:

$$V = \frac{PS - CR}{{V}_{1} - {V}_{2}} \times \frac{{V}_{{2}_{T 1}} - {V}_{{2}_{T 2}}}{{T}_{2} - {T}_{1}} ,$$

where V₁ is the first predefined temperature (e.g., V_{ref}), V₂ is the second predefined temperature (e.g., V_{be}), T₁ is the first temperature described above with reference to FIG. 4C (e.g., minimum operating temperature of the memory device), T₂ is the second temperature described above with reference to FIG. 4C (e.g., maximum operation temperature of the memory device, V₂_{_{T1}} is the magnitude of the second predefined voltage at T₁ (e.g., V_{be} at T₁) and V₂_{_{T2}} is the magnitude of the second predefined voltage at T₂ (e.g., V_{be} at T₂). Examples of methods can be used to implement memory devices with dual phase temperature sensors calibrated at a single temperature will now be described below with reference to FIGS. 5A-5C.

FIG. 5A is a flow diagram of an example method to implement memory devices with dual phase temperature sensors, in accordance with some embodiments of the present disclosure. The method 500 can be performed by processing logic or control logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the local media controller 135 and/or the TS 139 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, a temperature sensor is calibrated. For example, processing logic can cause the temperature sensor to be calibrated by using a dual phase scheme. In some implementations, the temperature sensor is a temperature sensor. The temperature sensor can be calibrated at a single temperature. In some embodiments, the single temperature is 90° C. Further details regarding calibration of the temperature sensor are described above with reference to FIGS. 3A-4C and will be described below with reference to FIG. 5B.

At operation 520, a temperature within a memory device is determined. For example, processing logic can cause the temperature within the memory device to be determined by using a dual phase scheme using the calibrated temperature sensor. Further details regarding determining the temperature within the memory device are described above with reference to FIGS. 3A-4C and will be described below with reference to FIG. 5C.

FIG. 5B is a flow diagram of an example method to perform the operation 510 to calibrate a temperature sensor, in accordance with some embodiments of the present disclosure. The method to perform the operation 510 can be performed by processing logic or control logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method to perform the operation 510 is performed by the local media controller 135 and/or the TS 139 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 512, a calibration reference phase value is determined. For example, processing logic can determine the calibration reference phase value during a reference phase of a temperature sensor (e.g., a temperature sensor) performed during calibration (e.g., trimming) of the temperature sensor. The calibration reference phase value can reflect an amount of time for a ramp voltage starting at a predefined starting value to reach a reference voltage value (“reference phase time”). In some implementations, the predefined starting value is greater than zero volts. In some implementations, the ramp voltage is produced by a ramp voltage source associated with a temperature sensor that increases the ramp voltage from a predefined starting value. In some implementations, the ramp voltage source includes a capacitor. For example, the capacitor can be coupled to a reference current source that charges the capacitor when enabled by a ramp enable signal.

In some implementations, determining the calibration reference phase value includes causing the reference phase to be performed during calibration of the temperature sensor. Causing the reference phase to be performed during calibration of the temperature sensor can include initiating the reference phase by causing the ramp voltage source to increase the ramp voltage from the predefined starting value, and terminating the reference phase in response to determining that the ramp voltage reaches the reference voltage value.

In some implementations, the calibration reference phase value is a calibration reference phase count corresponding to a number of clock signal pulses until the ramp voltage reaches the reference voltage value. In some implementations, determining the calibration reference phase value includes counting the number of clock signal pulses until the ramp voltage reaches the reference voltage value. The calibration time can be determined as the product of the calibration reference phase count and a length of time of a single pulse (e.g., from rising edge to rising edge).

At operation 514, a calibration sampling phase value is determined. For example, processing logic can determine the calibration sampling phase value during a sampling phase of the temperature sensor during calibration of the temperature sensor. The calibration sampling phase value can reflect an amount of time for a ramp voltage starting at a predefined starting value to reach a temperature-dependent voltage value produced by a temperature-dependent circuit of the temperature sensor at a chosen reference temperature (“sampling phase time”). In some implementations, the temperature-dependent circuit includes a bandgap circuit, and the temperature-dependent voltage value is defined by current flowing between a base of a transistor of the bandgap circuit and an emitter of the transistor (e.g., a base-to-emitter voltage).

In some implementations, determining the calibration sampling phase value includes causing the sampling phase to be performed during calibration of the temperature sensor. Causing the sampling phase to be performed during calibration of the temperature sensor can include initiating the sampling phase by causing the ramp voltage source to increase the ramp voltage from the predefined starting value, and terminating the reference phase in response to determining that the ramp voltage reaches the temperature-dependent voltage value.

In some implementations, the calibration sampling phase value is the number of clock signal pulses until the ramp voltage reaches the temperature-dependent voltage value. In some implementations, determining the calibration sampling phase value includes counting a number of clock signal pulses until the ramp voltage reaches the temperature-dependent voltage value. The sampling time can be determined as the product of the calibration sampling phase count and the length of time of a single clock signal pulse (e.g., from rising edge to rising edge).

In some implementations, the chosen reference temperature is about 90° C. To calibrate the temperature sensor, the reference voltage value can be tuned to the temperature-dependent voltage value at a predefined temperature. For example, the predefined temperature can be approximately 0° C.

In some implementations, voltage generator circuitry of the temperature sensor generates the reference voltage value at operation 512 and generates the temperature-dependent voltage value at operation 514. In some implementations, the predefined starting value of the ramp voltage is set by the voltage generator circuitry.

In some implementations, dual phase control circuitry of the temperature sensor selectively controls operation of the reference phase at operation 512 and operation of the sampling phase at operation 514. More specifically, the dual phase control circuitry can include the ramp voltage source to produce the ramp voltage that increases from the predefined starting value to the reference voltage value during the calibration reference phase and that increases from the predefined starting value to the temperature-dependent voltage value during the calibration sampling phase.

For example, determining the calibration reference phase value at operation 512 can include causing the dual phase control circuitry to use a comparator to output, by comparing the ramp voltage to the reference voltage value during the calibration reference phase, a first comparator signal. Phase value circuitry of the temperature sensor can receive the first comparator signal to determine when the ramp voltage reaches the reference voltage value in order to generate the calibration reference phase value. More specifically, the phase value circuitry can include a reference phase counter to generate the calibration reference phase value as a calibration reference phase count.

As another example, determining the calibration sampling phase value at operation 512 can include causing the dual phase control circuitry to use the comparator to output, by comparing the ramp voltage to the temperature-dependent voltage value during the calibration sampling phase, a second comparator signal. The phase value circuitry can receive the second comparator signal to determine when the ramp voltage reaches the temperature-dependent voltage value in order to generate the calibration sampling phase value. More specifically, the phase value circuitry can include a sampling phase counter to generate the calibration sampling phase value as a calibration sampling phase count.

At operation 516, a set of calibration parameters is stored. For example, processing logic can cause a set of calibration parameters including the calibration reference phase value and the calibration sampling phase value to be stored. In some implementations, the calibration reference phase value is stored in a calibration reference phase value register and the calibration sampling phase value is stored in a calibration sampling phase value register. In some implementations, the set of calibration parameters further includes the chosen reference temperature at which the temperature sensor was calibrated. As described above with reference to FIG. 4C and as will now be described below with reference to FIG. 5C, the set of calibration parameters can be used to determine a temperature measured by the calibrated temperature sensor. Further details regarding operations 512-516 are described above with reference to FIGS. 1-5B.

FIG. 5C is a flow diagram of an example method to perform the operation 520 to determine a temperature within a memory device, in accordance with some embodiments of the present disclosure. The method to perform the operation 520 can be performed by processing logic or control logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method to perform the operation 520 is performed by the TS 139 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 522, a reference phase value is determined. For example, processing logic can determine the reference phase value during a reference phase of a temperature sensor. The reference phase value can reflect an amount of time for a ramp voltage starting at a predefined starting value to reach a reference voltage value (“reference phase time”). In some implementations, the predefined starting value is greater than zero volts. In some implementations, the ramp voltage is produced by a ramp voltage source associated with a temperature sensor that increases the ramp voltage from a predefined starting value. In some implementations, the ramp voltage source includes a capacitor. For example, the capacitor can be coupled to a reference current source that charges the capacitor when enabled by a ramp enable signal.

In some implementations, determining the reference phase value includes causing the reference phase to be performed. Causing the reference phase to be performed can include initiating the reference phase by causing the ramp voltage source to increase the ramp voltage from the predefined starting value, and terminating the reference phase in response to determining that the ramp voltage reaches the reference voltage value.

In some implementations, the reference phase value is a reference phase count corresponding to a number of clock signal pulses until the ramp voltage reaches the reference voltage value. In some implementations, determining the reference phase value includes counting the number of clock signal pulses until the ramp voltage reaches the reference voltage value. The reference phase time can be determined as the product of the reference phase count and a length of time of a single pulse (e.g., from rising edge to rising edge).

At operation 524, a sampling phase value is determined. For example, processing logic can determine the sampling phase value during a sampling phase of the temperature sensor. The sampling phase value can reflect an amount of time for a ramp voltage starting at a predefined starting value to reach a temperature-dependent voltage value produced by a temperature-dependent circuit of the temperature sensor at a chosen reference temperature (“sampling phase time”). In some implementations, the temperature-dependent circuit includes a bandgap circuit, and the temperature-dependent voltage value is defined by current flowing between a base of a transistor of the bandgap circuit and an emitter of the transistor (e.g., a base-to-emitter voltage).

In some implementations, determining the sampling phase value includes causing the sampling phase to be performed. Causing the sampling phase to be performed can include initiating the sampling phase by causing the ramp voltage source to increase the ramp voltage from the predefined starting value, and terminating the reference phase in response to determining that the ramp voltage reaches the temperature-dependent voltage value.

In some implementations, the sampling phase value is a sampling count corresponding to a number of clock signal pulses until the ramp voltage reaches the temperature-dependent voltage value. In some implementations, determining the sampling phase value includes counting a number of clock signal pulses until the ramp voltage reaches the temperature-dependent voltage value. The sampling time can be determined as the product of the sampling phase count and the length of time of a single clock signal pulse (e.g., from rising edge to rising edge).

In some implementations, voltage generator circuitry of the temperature sensor generates the reference voltage value at operation 522 and generates the temperature-dependent voltage value at operation 524. In some implementations, the predefined starting value of the ramp voltage is set by the voltage generator circuitry.

In some implementations, dual phase control circuitry of the temperature sensor selectively controls operation of the reference phase at operation 522 and operation of the sampling phase at operation 524. More specifically, the dual phase control circuitry can include the ramp voltage source to produce the ramp voltage that increases from the predefined starting value to the reference voltage value during the reference phase and that increases from the predefined starting value to the temperature-dependent voltage value during the sampling phase.

For example, determining the reference phase value at operation 522 can include causing the dual phase control circuitry to use a comparator to output, by comparing the ramp voltage to the reference voltage value during the reference phase, a first comparator signal. Phase value circuitry of the temperature sensor can receive the first comparator signal to determine when the ramp voltage reaches the reference voltage value in order to generate the reference phase value. More specifically, the phase value circuitry can include a reference phase counter to generate the reference phase value as a reference phase count.

As another example, determining the sampling phase value at operation 522 can include causing the dual phase control circuitry to use the comparator to output, by comparing the ramp voltage to the temperature-dependent voltage value during the sampling phase, a second comparator signal. The phase value circuitry can receive the second comparator signal to determine when the ramp voltage reaches the temperature-dependent voltage value in order to generate the sampling phase value. More specifically, the phase value circuitry can include a sampling phase counter to generate the sampling phase value as a sampling phase count.

At operation 526, a temperature is determined. For example, processing logic can cause a temperature within the memory device to be determined based on the reference phase value and the sampling phase value. More specifically, the temperature is determined for a region surrounding the temperature sensor. In some implementations, causing the temperature to be determined includes processing logic determining the temperature based on a set of parameters including the reference phase value and the sampling phase value. In some implementations, causing the temperature to be determined includes sending the set of parameters to the local media controller to determine the temperature. In some implementations, causing the temperature within the memory device to be determined includes identifying a calibration temperature within the memory device associated with a calibration operation performed to calibrate the temperature sensor (e.g., the method 510 of FIGS. 5A-5B), determining a corrected reference phase value based on the reference phase value, the sampling phase value, and a calibration reference value (e.g., the calibration reference phase value determined at operation 512 of FIG. 5B), determining a resolution value based on the calibration reference value and the corrected reference phase value, and causing the temperature within the memory device to be determined based on a calibration sampling phase value (e.g., the calibration sampling phase value determined at operation 514 of FIG. 5B), the corrected reference phase value, the resolution value, and the calibration temperature within the memory device. Further details regarding operations 522-526 are described above with reference to FIGS. 1-5B.

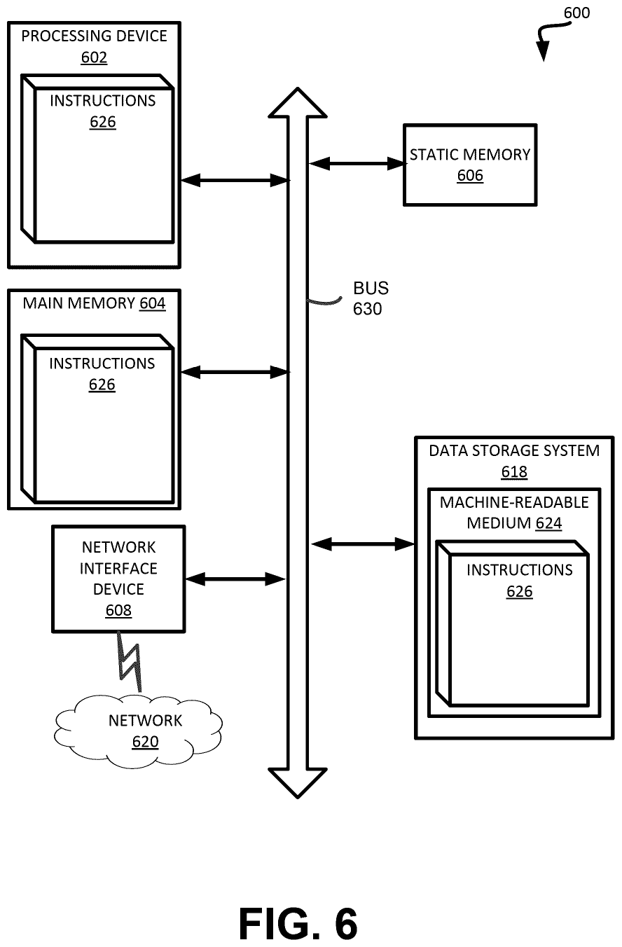

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the local media controller 135 and/or the TS 139 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In some embodiments, the instructions 626 include instructions to implement functionality to determine temperature based on a calibration time metric and a sampling time metric obtained using a TS (e.g., the TS 139 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a memory array;
a temperature sensor comprising a temperature-dependent circuit;
a ramp voltage source producing a ramp voltage that increases from a predefined starting value; and
at least one processing device, operatively coupled with the memory array, the temperature sensor, and the ramp voltage source, the at least one processing device to perform operations comprising:
determining a reference phase value reflecting a first amount of time for the ramp voltage starting at the predefined starting value to reach a reference voltage value;
determining a sampling phase value reflecting a second amount of time for the ramp voltage starting at the predefined starting value to reach a temperature-dependent voltage value produced by the temperature-dependent circuit; and
determining, based on the reference phase value and the sampling phase value, a temperature within the memory device.

2. The memory device of claim 1, wherein determining the reference phase value further comprises: counting a number of clock signal pulses until the ramp voltage reaches the reference voltage value.

3. The memory device of claim 1, wherein determining the sampling phase value further comprises: counting a number of clock signal pulses until the ramp voltage reaches the temperature-dependent voltage value.

4. The memory device of claim 1, wherein the temperature-dependent circuit comprises a bandgap circuit, and wherein the temperature-dependent voltage value is defined by a current flowing between a base of a transistor of the bandgap circuit and an emitter of the transistor.

5. The memory device of claim 1, wherein the ramp voltage source comprises a capacitor.

6. The memory device of claim 1, wherein the operations further comprise:
determining a calibration reference phase value reflecting a third amount of time for the ramp voltage starting at the predefined starting value to reach the reference voltage value; and
determining a calibration sampling phase value reflecting a fourth amount of time for the ramp voltage starting at the predefined starting value to reach a calibration temperature-dependent voltage value produced by the temperature-dependent circuit at a chosen reference temperature.

7. The memory device of claim 6, wherein determining the temperature within the memory device further comprises:
determining a corrected reference phase value based on the reference phase value, the sampling phase value, and the calibration reference phase value;
determining a resolution value based on the calibration reference phase value and the corrected reference phase value; and
determining the temperature within the memory device based on the calibration sampling phase value, the corrected reference phase value, the resolution value, and the chosen reference temperature within the memory device.

8. A method comprising:
determining, by at least one processing device, a reference phase value reflecting a first amount of time for a ramp voltage starting at a predefined starting value to reach a reference voltage value, wherein the ramp voltage is produced by a ramp voltage source associated with a temperature sensor that increases the ramp voltage from the predefined starting value;
determining, by the at least one processing device, a sampling phase value reflecting a second amount of time for the ramp voltage starting at the predefined starting value to reach a temperature-dependent voltage value produced by a temperature-dependent circuit of the temperature sensor; and
determining, by the at least one processing device based on the reference phase value and the sampling phase value, a temperature within a memory device to be determined.

9. The method of claim 8, wherein determining the reference phase value further comprises:
counting a number of clock signal pulses until the ramp voltage reaches the reference voltage value.

10. The method of claim 8, wherein determining the sampling phase value further comprises:
counting a number of clock signal pulses until the ramp voltage reaches the temperature-dependent voltage value.

11. The method of claim 8, wherein the temperature-dependent voltage value is defined by current flowing between a base of a transistor of a bandgap circuit of the temperature-dependent circuit and an emitter of the transistor.

12. The method of claim 8, wherein determining the reference phase value further comprises causing the ramp voltage source to produce the ramp voltage, wherein determining the sampling phase value further comprises causing the ramp voltage source to produce the ramp voltage, and wherein the ramp voltage source comprises capacitor.

13. The method of claim 8, further comprising causing, by the at least one processing device, a calibration operation of the temperature sensor to be performed, wherein causing the calibration operation to be performed comprises:
determining a calibration reference phase value reflecting a third amount of time for the ramp voltage starting at the predefined starting value to reach the reference voltage value; and
determining a calibration sampling phase value reflecting a fourth amount of time for the ramp voltage starting at the predefined starting value to reach a calibration temperature-dependent voltage value produced by the temperature-dependent circuit at a chosen reference temperature.

14. The method of claim 13, wherein causing the temperature within the memory device to be determined further comprises:
determining a corrected reference phase value based on the reference phase value, the sampling phase value, and the calibration reference phase value;
determining a resolution value based on the calibration reference phase value and the corrected reference phase value; and
determining the temperature within the memory device based on the calibration sampling phase value, the corrected reference phase value, the resolution value, and the chosen reference temperature within the memory device.

15. A system comprising:
a temperature sensor within a memory device;
voltage generator circuitry to generate a reference voltage value and a temperature-dependent voltage value associated with a temperature-dependent circuit;
dual phase control circuitry to selectively control operation of a reference phase for the temperature sensor and a sampling phase for the temperature sensor, wherein the dual phase control circuitry comprises a ramp voltage source to produce a ramp voltage that increases from a predefined starting value to the reference voltage value during the reference phase and that increases from the predefined starting value to the temperature-dependent voltage value during the sampling phase, and wherein the predefined starting value is set by the voltage generator circuitry;
phase value circuitry of the temperature sensor to generate a reference phase count corresponding to a first number of clock signal pulses until the ramp voltage reaches the reference voltage value during the reference phase, and a sampling phase count corresponding to a second number of clock signal pulses until the ramp voltage reaches the temperature-dependent voltage value during the sampling phase; and
a processing device, operatively coupled with a memory, to perform operations comprising:
causing the reference phase to be performed to determine the reference phase count;
causing the sampling phase to be performed to determine the sampling phase count; and
causing, based on the reference phase count and the sampling phase count, a temperature within the memory device to be determined.

16. The system of claim 15, wherein the dual phase control circuitry further comprises a comparator to:
output, by comparing the ramp voltage to the reference voltage value during the reference phase, a first comparator signal, wherein the first comparator signal is received by the phase value circuitry to determine when the ramp voltage reaches the reference voltage value in order to generate the reference phase count; and
output, by comparing the ramp voltage to the temperature-dependent voltage value during the sampling phase, a second comparator signal, wherein the second comparator signal is received by the phase value circuitry to determine when the ramp voltage reaches the temperature-dependent voltage value in order to generate the sampling phase count.

17. The system of claim 15, wherein the temperature-dependent circuit comprises a bandgap circuit, and wherein the temperature-dependent voltage value is defined by current flowing between a base of a transistor of the bandgap circuit and an emitter of the transistor.

18. The system of claim 15, wherein the ramp voltage source comprises a capacitor.

19. The system of claim 15, wherein the operations further comprise causing a calibration operation of the temperature sensor to be performed, and wherein causing the calibration operation to be performed comprises:
determining a calibration reference phase value reflecting a third amount of time for the ramp voltage starting at the predefined starting value to reach the reference voltage value; and
determining a calibration sampling phase value reflecting a fourth amount of time for the ramp voltage starting at the predefined starting value to reach a calibration temperature-dependent voltage value produced by the temperature-dependent circuit at a chosen reference temperature.

20. The system of claim 19, wherein causing the temperature within the memory device to be determined further comprises:
identifying a calibration temperature within the memory device associated with the calibration operation;
determining a corrected reference phase value based on the calibration reference phase value, the calibration sampling phase value, and the calibration reference phase value;
determining a resolution value based on the calibration reference phase value and the corrected reference phase value; and
determining the temperature within the memory device based on the calibration sampling phase value, the corrected reference phase value, the resolution value, and the calibration temperature within the memory device.
